(19) United States
(12) Patent Application Publication
(10) Pub. No.: US 2014/0154815 A1
(43) Pub. Date: Jun. 5, 2014

(54) Luminescent Compounds, Complexes and Their Uses

(71) Applicants: Sim-Wan Annie Bligh, London (GB); Nicholas Paul Chatterton, London (GB); Nicholas James Wardle, London (GB); Jason Lee Sarris, London (GB); Gaoyun Chen, London (GB)

(72) Inventors: Sim-Wan Annie Bligh, London (GB); Nicholas Paul Chatterton, London (GB); Nicholas James Wardle, London (GB); Jason Lee Sarris, London (GB); Gaoyun Chen, London (GB)

(73) Assignee: LONDON METROPOLITAN UNIVERSITY, London (GB)

(21) Appl. No.: 14/111,610

(22) PCT Filed: Apr. 13, 2012
(86) PCT No.: PCT/GB2012/050818

§ 371 Date: Jan. 27, 2014

(30) Foreign Application Priority Data
Apr. 15, 2011 (GB) 1106426.8

(51) Int. Cl. G01N 21/77; C07F 5/00

(52) U.S. Cl. CPC G01N 21/77; C07F 5/00
USPC 436/163; 534/16

(57) ABSTRACT

A method of changing the fluorescent properties of a complex, the method comprising: providing a first complex comprising a multidentate ligand that is coordinated to a lanthanide ion, wherein the lanthanide is selected from europium and terbium and the multidentate ligand has at least one optionally substituted phthalimide group coordinated to the lanthanide ion, contacting the complex with an aqueous liquid medium under appropriate conditions, such that at least one phthalimide group is hydrolysed to a phthalamate group, to form a second complex. Complexes and compounds are also disclosed.

### FIELD OF THE INVENTION

The present invention relates to luminescent complexes containing europium and/or terbium, compounds for use in the complexes, and uses of the complexes, for example in the detection of changes in pH.

### BACKGROUND

Chemical sensors using lanthanide luminescence have been investigated for a number of years. It has been found that lanthanide chelate compounds can have long excited state lifetimes, often over about 1 ms, compared to fluorescent organic molecules (that do not include a lanthanide). They are therefore useful in time-resolved fluorometric measurement studies, as they eliminate undesired background fluorescence, which decays typically within nanoseconds, and have very high sensitivity. They have in some circumstances been found to be effective at analyte concentrations as low as 10⁻¹⁵M, due to the high signal to noise ratio.

There is a continuing desire to provide alternative lanthanide complexes to those in the prior art, particularly lanthanide chelate complexes with improved properties, such as intensity of luminescence.

### SUMMARY OF THE INVENTION

The present inventors have found that certain europium and terbium complexes, in which europium or terbium is coordinated to a phthalimide group, display a surprising change in fluorescent behaviour when the phthalimide group is hydrolysed to a phthalamate group. In particular, the luminescence has generally been found to increase substantially. Generally, hydrolysis of the phthalimide group in the complex to a phthalamate is not reversible, at least not by simply lowering the pH of a medium in which the complexes are contained. Accordingly, the europium and terbium complexes, in which europium or terbium is coordinated to a phthalimide derivative, can be used in variety of applications, for example as a pH sensor. The resultant complexes, i.e. those containing a phthalamate group, also find use in a number of applications, as described herein.

In a first aspect, the present invention provides a method of changing the fluorescent properties of a complex, the method comprising:
providing a first complex comprising a multidentate ligand that is coordinated to a lanthanide ion,
wherein the lanthanide is selected from europium and terbium and the multidentate ligand has at least one optionally substituted phthalimide group coordinated to the lanthanide ion,
contacting the complex with an aqueous liquid medium under appropriate conditions, such that at least one phthalimide group is hydrolysed to a phthalamate group, to form a second complex.

In a second aspect, the present invention provides a complex comprising a multidentate ligand that is coordinated to a lanthanide ion,

wherein the lanthanide is selected from europium and terbium and the multidentate ligand has (i) at least one optionally substituted phthalimide group coordinated to the lanthanide ion or (ii) at least one optionally substituted phthalamate group coordinated to the lanthanide ion.

Accordingly, in an embodiment of the second aspect, the present invention provides a complex comprising a multidentate ligand that is coordinated to a lanthanide ion,

wherein the lanthanide is selected from europium and terbium and the multidentate ligand has at least one optionally substituted phthalimide group coordinated to the lanthanide ion. This complex shall be described herein as a first complex.

Accordingly, in an embodiment of the second aspect, the present invention provides a complex comprising a multidentate ligand that is coordinated to a lanthanide ion, wherein the lanthanide is selected from europium and terbium and the multidentate ligand has at least one optionally substituted phthalamate group coordinated to the lanthanide ion. This complex shall be described herein as a second complex.

Reference to the second complex does not mean the first complex is present, unless stated. The method of the first aspect may be used to synthesize the second complex from the first complex.

In a second aspect, the present invention further provides a complex comprising
a lanthanide ion and a ligand of formula (I)

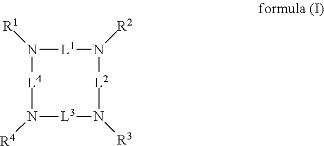

wherein the lanthanide is selected from europium and terbium,

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

L⁵ and L⁶ are each independently an organic linker group,

X¹ is an optionally substituted phthalimide group or optionally substituted phthalamate group, and

X² is a group that binds to the lanthanide ion other than a substituted phthalimide group and a optionally substituted phthalamate group,

wherein each R⁵ is independently selected from H and an optionally substituted hydrocarbon group,

and at least one of R¹, R², R³ and R⁴ is L⁵-X¹.

In an embodiment, the first complex comprises
a lanthanide ion and a ligand of the formula (I)

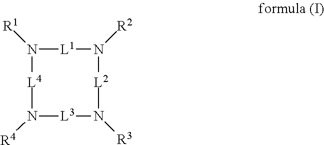

wherein the lanthanide is selected from europium and terbium,

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

L⁵ and L⁶ are each independently an organic linker group,

X¹ is an optionally substituted phthalimide group, and

X² is a group that binds to the lanthanide ion other than the optionally substituted phthalimide group,

wherein each R⁵ is independently selected from H and an optionally substituted hydrocarbon group,

and at least one of R¹, R², R³ and R⁴ is L⁵-X¹.

In an embodiment, the second complex comprises
a lanthanide ion and a ligand of the formula (I)

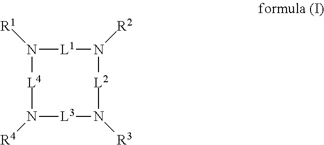

wherein the lanthanide is selected from europium and terbium,

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

L⁵ and L⁶ are each independently an organic linker group,

X¹ is an optionally substituted phthalamate group, and

X² is a group that binds to the lanthanide ion other than an optionally substituted phthalamate group,

wherein each R⁵ is independently selected from H and an optionally substituted hydrocarbon group,

and at least one of R¹, R², R³ and R⁴ is L⁵-X¹.

In a third aspect, the present invention provides a macrocyclic compound, wherein the compound is of formula (I)

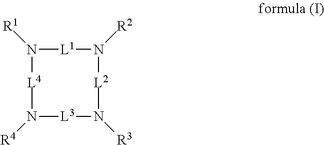

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

each L⁵ is independently alkylene,

each L⁶ is independently an organic linker group,

X¹ is an optionally substituted phthalimide group or optionally substituted phthalamate group, and

X² is a group that binds to a lanthanide selected from europium and terbium other than an optionally substituted phthalimide group and an optionally substituted phthalamate group,

wherein each R⁵ is independently selected from H and an optionally substituted hydrocarbon group,

and at least one of R¹, R², R³ and R⁴ is L⁵-X¹,

excluding 1, 4, 7, 10-tetraazacyclododecane-1-[N-(phthalimide) ethyl]-4,7,10-triacetic acid (D03A-EP).

In a third aspect, the present invention provides a macrocyclic compound, wherein the compound is of formula (I)

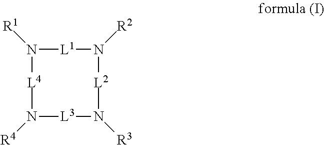

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

L⁵ and L⁶ are each independently an organic linker group,

X¹ is an optionally substituted phthalimide group, and

X² is a group that binds to a lanthanide ion selected from europium and terbium other than an optionally substituted phthalimide group,

wherein each R⁵ is independently selected from H and an optionally substituted hydrocarbon group,

and at least two of R¹, R², R³ and R⁴ is L⁵-X¹.

In a third aspect, the present invention provides a macrocyclic compound, wherein the compound is of formula (I)

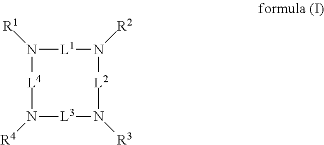

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

L⁵ and L⁶ are each independently an organic linker group,

X¹ is an optionally substituted phthalamate group, and

X² is a group that binds to a lanthanide ion, wherein the lanthanide is selected from europium and terbium other than an optionally substituted phthalamate group,

wherein each R⁵ is independently selected from H and an optionally substituted hydrocarbon group,

and at least one of R¹, R², R³ and R⁴ is L⁵-X¹.

In a fourth aspect, the present invention provides a substrate having thereon or therein a complex according to the second aspect, wherein, if the substrate has therein a complex according to the second aspect, the substrate can absorb an aqueous liquid medium such that it can contact the complex. In an embodiment, the complex may be the first complex of the second aspect. In an embodiment, the complex may be the second complex of the second aspect.

In a fifth aspect, the present invention provides a kit comprising
the first complex according the second aspect and, separately,
a container containing an aqueous liquid medium at an appropriate pH, such that, when the liquid medium is contacted with the first complex at least one phthalimide group of the first complex is hydrolysed.

In a sixth aspect, the present invention provides a composition comprising a complex according to the second aspect and/or a compound according to the third aspect, and a carrier medium. In an embodiment, the complex may be the first complex of the second aspect. In an embodiment, the complex may be the second complex of the second aspect.

In a seventh aspect, the present invention provides use of a complex according to the second aspect for detecting a change in pH. In an embodiment, the complex may be the first complex of the second aspect. In an embodiment, the complex may be the second complex of the second aspect.

In a eighth aspect, the present invention provides use of a complex according to the second aspect as a security marker. In an embodiment, the complex may be the first complex of the second aspect. In an embodiment, the complex may be the second complex of the second aspect.

In a ninth aspect, the present invention provides use of a complex according to the second aspect as a molecular switch. In an embodiment, the complex may be the first complex of the second aspect. In an embodiment, the complex may be the second complex of the second aspect.

In a tenth aspect, the present invention provides use of a complex according to the second aspect as a metal ion sensor. In an embodiment, the complex may be the first complex of the second aspect. In an embodiment, the complex may be the second complex of the second aspect.

### BRIEF DESCRIPTION OF THE FIGURES

FIG. 1 illustrates a method of synthesising gadolinium complexes. Europium and Terbium complexes according to embodiments of the present invention can be made in an analogous manner.

FIG. 2(a) illustrates the transition between different complexes and compounds according to embodiments of the present invention.

FIG. 2(b) illustrates the change in luminescence intensity with a change in pH for an embodiment of a second complex (containing Europium) according to the second aspect of the invention, as described in Example 1 in more detail.

FIG. 3 illustrates the change in luminescence intensity with a change in pH for an embodiment of a second complex (containing Europium) according to the second aspect of the invention, as described in Example 1 in more detail.

FIG. 4 illustrates the change in luminescence intensity with a change in pH for an embodiment of a second complex (containing Terbium) according to the second aspect of the invention, as described in Example 1 in more detail.

FIG. 5 illustrates a schematic representation of an implication logic gate using an embodiment of the second complex.

FIG. 6A illustrates the luminescence of various complexes according to the present invention on sample banknote paper.

FIG. 6B shows the placement of the various complexes on sample banknote paper illustrated in FIG. 6A.

FIG. 7A illustrates the luminescence of various complexes according to the present invention on sample banknote paper.

FIG. 7B shows the placement of the various complexes on sample banknote paper illustrated in FIG. 7A.

FIG. 8A shows a photograph in room light of agarose gel containing an embodiment of a second complex according to the present invention, as described in the Examples in more detail below.

FIG. 8B shows a photograph of the same agarose gel composition of FIG. 6A with the room light off.

FIG. 8C shows a photograph of the same agarose gel composition of FIG. 6A, with the room light off, but being illuminated with UV light at a wavelength of 254 nm.

FIG. 9 illustrates the change in luminescence intensity in the presence of various metal cations for an embodiment of a second complex (containing Terbium) according to the second aspect of the invention, as described in Example 6.

### DETAILED DESCRIPTION OF THE INVENTION

The present invention provides the aspects mentioned herein.

In a first aspect, the present invention provides a method of changing the fluorescent properties of a complex, the method comprising:
providing a first complex comprising a multidentate ligand that is coordinated to a lanthanide ion,
wherein the lanthanide is selected from europium and terbium and the multidentate ligand has at least one optionally substituted phthalimide group coordinated to the lanthanide ion,
contacting the complex with an aqueous liquid medium under appropriate conditions, such that at least one phthalimide group is hydrolysed to a phthalamate group, to form a second complex.

In the above method, the complex contacted with the aqueous liquid medium is a complex according to the second aspect, where the multidentate ligand has at least one optionally substituted phthalimide group coordinated to the lanthanide ion. The method of the first aspect may be used to synthesize the second complex, as described herein, from the first complex.

The complex will be described in more detail below.

The method of the first aspect involves contacting the first complex with the aqueous liquid medium under appropriate conditions, such that at least one optionally substituted phthalimide group in the complex is hydrolysed to at least one optionally substituted phthalamate group. Optionally, if the first complex comprises more than one phthalimide group, all optionally substituted phthalimide groups in the complex are hydrolysed to optionally substituted phthalamate groups. The aqueous liquid medium contains water and optionally one or more additives. The appropriate conditions may be such that the pH of the aqueous liquid medium is sufficiently high to hydrolyse a phthalimide group of the complex to a phthalamate group of the complex. The appropriate conditions may be such that the pH of the aqueous liquid medium is 9 or above, optionally 9.5 or above, optionally 10 or above, optionally 10.5 or above.

Prior to the hydrolysing of the at least one optionally substituted phthalimide group, the first complex may be in or on a substrate, e.g. as described herein. Prior to the hydrolysing of the at least one optionally substituted phthalimide group, the composition may be in a carrier medium, e.g. as described herein. Prior to the hydrolysing of the at least one optionally substituted phthalimide group, the first complex may be present in or on the substrate or in the carrier medium at a concentration of 0.01 mM or more, optionally a concentration of 0.05 mM or more, optionally a concentration of 0.1 mM or more, optionally a concentration of 0.5 mM or more, optionally a concentration of 1 mM or more, optionally a concentration of 1 mM or more, optionally a concentration of 2 mM or more, optionally a concentration of 3 mM or more, optionally a concentration of 4 mM or more, optionally a concentration of 4 mM or more, optionally a concentration of 5 mM or more.

The method may involve contacting the first complex with an aqueous liquid medium at conditions under which the optionally substituted phthalimide group or groups in the complex is or are not hydrolysed to an optionally substituted phthalamate group or groups, and then altering the conditions such that at least one optionally substituted phthalimide group in the complex is hydrolysed to at least one optionally substituted phthalamate group. The method may involve contacting the first complex with an aqueous liquid medium at a pH of 9 or below, optionally 10 or below, and raising the pH such that at least one optionally substituted phthalimide group in the first complex is hydrolysed to at least one optionally substituted phthalamate group, optionally to a pH of 9 or more, optionally 9.5 or more, optionally 10 or more, optionally 10.5 or more.

The method may involve measuring the luminescence, e.g. fluorescence or phosphorescence, of the complex before and/or after the contacting of the complex with the aqueous liquid medium. Measuring the luminescence (e.g. fluorescence) may include measuring a value selected from: (i) the wavelength of maximum luminescence, (ii) the intensity of luminescence at the wavelength of maximum luminescence and (iii) the luminescence lifetime.

In a second aspect the present invention provides a complex comprising a multidentate ligand that is coordinated to a lanthanide ion,

wherein the lanthanide is selected from europium and terbium and the multidentate ligand has (i) at least one optionally substituted phthalimide group coordinated to the lanthanide ion or (ii) at least one optionally substituted phthalamate group coordinated to the lanthanide ion.

The at least one optionally substituted phthalimide group may be a group of the formula (II):

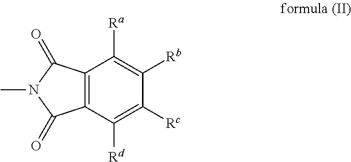

wherein R^{a}, R^{b}, R^{c} and R^{d} are each independently selected from H and a substituent. The substituent for R^{a}, R^{b}, R^{c} and R^{d} may each independently be selected from alkyl, alkenyl, alkynyl, —O-alkyl, —O-alkanoyl, halogen, heterocyclyl, alkoxycarbonyl, hydroxy, mercapto, nitro, acyloxy, hydroxy, thiol, acyl, cycloalkyl, cycloalkenyl, substituted alkyl, substituted alkoxy, substituted alkenyl, substituted alkynyl, substituted cycloalkyl, substituted cycloalkenyl, amino, substituted amino, aminoacyl, acylamino, alkaryl, aryl, aryloxy, azido, carboxy, carboxyalkyl, cyano, halo, nitro, heteroaryl, heteroaryloxy, heterocyclic, heterocyclooxy, aminoacyloxy, oxyacylamino, thioalkoxy, substituted thioalkoxy, thioaryloxy, thioheteroaryloxy, —SO-alkyl, —SO-substituted alkyl, —SO-aryl, —SO-heteroaryl, —SO₂-alkyl, —SO₂-substituted alkyl, —SO₂-aryl and —SO₂— heteroaryl.

In an embodiment, at least two of R^{a}, R^{b}, R^{c} and R^{d} together form a ring, which may, for example be selected from an alkyl or aryl ring. In an embodiment, all of R^{a}, R^{b}, R^{c} and R^{d} are H.

The at least one optionally substituted phthalamate group may be of the formula (III):

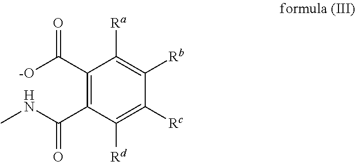

wherein R^{a}, R^{b}, R^{c} and R^{d} are selected from H and a substituent. The substituent for R^{a}, R^{b}, R^{c} and R^{d} may each independently be selected from alkyl, alkenyl, alkynyl, —O-alkyl, —O-alkanoyl, halogen, heterocyclyl, alkoxycarbonyl, hydroxy, mercapto, nitro, acyloxy, hydroxy, thiol, acyl, cycloalkyl, cycloalkenyl, substituted alkyl, substituted alkoxy, substituted alkenyl, substituted alkynyl, substituted cycloalkyl, substituted cycloalkenyl, amino, substituted amino, aminoacyl, acylamino, alkaryl, aryl, aryloxy, azido, carboxy, carboxyalkyl, cyano, nitro, heteroaryl, heteroaryloxy, heterocyclic, heterocyclooxy, aminoacyloxy, oxyacylamino, thioalkoxy, substituted thioalkoxy, thioaryloxy, thioheteroaryloxy, —SO-alkyl, —SO-substituted alkyl, —SO-aryl, —SO-heteroaryl, —SO₂-alkyl, —SO₂-substituted alkyl, —SO₂-aryl and —SO₂— heteroaryl. In the complexes of the present invention, the —CO₂⁻ species in the phthalamate group is preferably unprotonated as shown. In the compounds of the present invention, optionally the —CO₂⁻ species in the phthalamate group is protonated. The compounds may also be salts in which the phthalamate group is unprotonated, as shown above, and wherein one or more counterions are present. The counter ions may be any suitable metal ion, for example a metal ion of an alkali metal or an alkali earth metal.

In an embodiment, at least two of R^{a}, R^{b}, R^{c} and R^{d} together form a ring, which may, for example be selected from an alkyl or aryl ring. In an embodiment, all of R^{a}, R^{b}, R^{c} and R^{d} are H.

Accordingly, in an embodiment of the second aspect, the present invention provides a complex comprising a multidentate ligand that is coordinated to a lanthanide ion,

wherein the lanthanide is selected from europium and terbium and the multidentate ligand has at least one optionally substituted phthalimide group coordinated to the lanthanide ion. This complex shall be described herein as a first complex. In an embodiment, the multidentate ligand has at least two, optionally at least three, optionally at least four, optionally substituted phthalimide groups coordinated to the lanthanide ion.

Accordingly, in an embodiment of the second aspect, the present invention provides a complex comprising a multidentate ligand that is coordinated to a lanthanide ion,

wherein the lanthanide is selected from europium and terbium and the multidentate ligand has at least one optionally substituted phthalamate group coordinated to the lanthanide ion. This complex shall be described herein as a second complex. Reference to the second complex does not mean the first complex is present, unless stated. The method of the first aspect may be used to synthesize the second complex from the first complex. In an embodiment, the multidentate ligand has at least two, optionally at least three, optionally at least four, optionally substituted phthalamate groups coordinated to the lanthanide ion.

In a second aspect, the present invention further provides a complex comprising
a lanthanide ion and a ligand of formula (I)

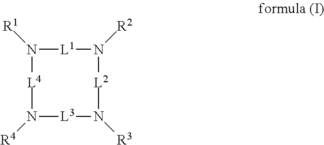

wherein the lanthanide is selected from europium and terbium,

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

L⁵ and L⁶ are each independently an organic linker group,

X¹ is an optionally substituted phthalimide group or optionally substituted phthalamate group, and

X² is a group that binds to the lanthanide ion other than a substituted phthalimide group and a optionally substituted phthalamate group,

wherein each R⁵ is independently selected from H and an optionally substituted hydrocarbon group,

and at least one of R¹, R², R³ and R⁴ is L⁵-X¹.

In an embodiment, the first complex comprises
a lanthanide ion and a ligand of the formula (I)

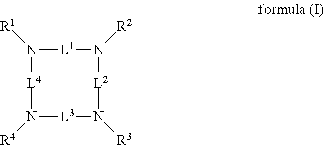

wherein the lanthanide is selected from europium and terbium,

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

L⁵ and L⁶ are each independently an organic linker group,

X¹ is an optionally substituted phthalimide group, and

X² is a group that binds to the lanthanide ion other than the optionally substituted phthalimide group,

wherein each R⁵ is independently selected from H and an optionally substituted hydrocarbon group,

and at least one of R¹, R², R³ and R⁴ is L⁵-X¹.

In an embodiment, the second complex comprises
a lanthanide ion and a ligand of the formula (I)

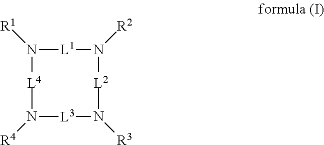

wherein the lanthanide is selected from europium and terbium,

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

L⁵ and L⁶ are each independently an organic linker group,

X¹ is an optionally substituted phthalamate group, and

X² is a group that binds to the lanthanide ion other than an optionally substituted phthalamate group,

wherein each R⁵ is independently selected from H and an optionally substituted hydrocarbon group,

and at least one of R¹, R², R³ and R⁴ is L⁵-X¹.

In a third aspect, the present invention provides a macrocyclic compound for forming a first complex as described herein, wherein the compound is of formula (I)

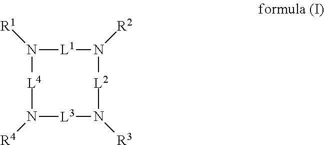

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

each L⁵ is independently alkylene,

each L⁶ is independently an organic linker group,

X¹ is an optionally substituted phthalimide group, and

X² is a group that binds to a lanthanide ion, wherein the lanthanide is selected from europium and terbium, other than an optionally substituted phthalimide group,

wherein each R⁵ is independently selected from H and an optionally substituted hydrocarbon group,

and at least one of R¹, R², R³ and R⁴ is L⁵-X¹,

excluding 1,4,7,10-tetraazacyclododecane-1-[N-(phthalimide) ethyl]-4,7,10-triacetic acid (D03A-EP). This compound shall be termed a first compound herein.

In a third aspect, the present invention provides a macrocyclic compound, wherein the compound is of formula (I)

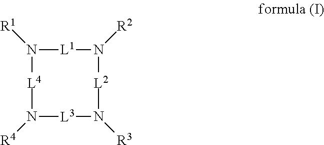

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

L⁵ and L⁶ are each independently an organic linker group,

X¹ is an optionally substituted phthalimide group, and

X² is a group that binds to a lanthanide ion selected from europium and terbium other than an optionally substituted phthalimide group,

wherein each R⁵ is independently selected from H and an optionally substituted hydrocarbon group,

and at least two of R¹, R², R³ and R⁴ is L⁵-X¹. This compound shall be termed a first compound herein.

In a third aspect, the present invention provides a macrocyclic compound for forming the second complex as described herein, wherein the compound is of formula (I)

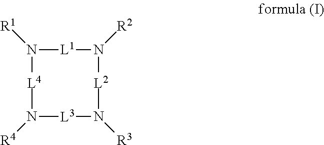

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

L⁵ and L⁶ are each independently an organic linker group,

X¹ is an optionally substituted phthalamate group, and

X² is a group that binds to a lanthanide ion, wherein the lanthanide is selected from europium and terbium, other than an optionally substituted phthalamate group,

wherein each R⁵ is independently selected from H and an optionally substituted hydrocarbon group,

and at least one of R¹, R², R³ and R⁴ is L⁵-X¹. This compound shall be termed a second compound herein. Reference to the second compound does not mean that the first compound is present, unless stated.

In a third aspect, the present invention provides a macrocyclic compound for forming the second complex as described herein, wherein the compound is of formula (I)

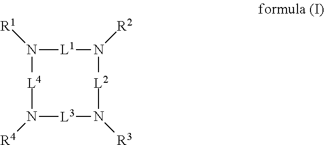

L¹, L², L³, L⁴ are each selected from —(CR⁵R⁵)ₙ—, wherein n is 2 or 3,

R¹, R², R³ and R⁴ are each independently selected from L⁵-X¹ and L⁶-X²,

each L⁵ is independently alkylene,

each L⁶ is independently an organic linker group,

X¹ is optionally substituted phthalamate group, and

X² is a group that binds to a lanthanide ion, wherein the lanthanide is selected from europium and terbium, other than an optionally substituted phthalamate group,

wherein each R⁵ is independently selected from H and an optionally substituted hydrocarbon group,

and at least one of R¹, R², R³ and R⁴ is L⁵-X¹.

In an embodiment, in any of the above formulae, L¹, L², L³, L⁴ are each selected from —(CR⁵R⁵)ₙ—, wherein n is 2 or 3, and each R⁵ in —(CR⁵R⁵)ₙ— is H. In an embodiment, in any of the above formulae, L¹, L², L³, L⁴ are each selected from —(CR⁵R⁵)ₙ—, wherein n is 2, and each R⁵ in —(CR⁵R⁵)ₙ— is H.

In an embodiment, in any of the above formulae, at least two of R¹, R², R³ and R⁴ is L⁵-X¹. In an embodiment, at least three of R¹, R², R³ and R⁴ is L⁵-X¹. In an embodiment, all of R¹, R², R³ and R⁴ are L⁵-X¹.

In an embodiment, in the first complex and/or the first compound, each X¹ is an optionally substituted phthalimide group. In an embodiment, in the second complex and/or the second compound, each X¹ is an optionally substituted phthalamate group.

In some embodiments described above, L⁵ and L⁶ are each independently an organic linker group. The organic linker group in L⁵ and/or L⁶ may comprise or be a hydrocarbon group. The organic linker group in L⁵ and/or L⁶ may comprise from 1 to 10 carbon atoms, optionally 1 to 5 carbon atoms, optionally 1 to 3 carbon atoms. The organic linker group in L⁵ and/or L⁶ may comprise or be a group selected from optionally substituted alkylene, optionally substituted alkenylene and optionally substituted alkynylene. The group selected from optionally substituted alkylene, optionally substituted alkenylene and optionally substituted alkynylene may comprise from 1 to 10 carbon atoms, optionally 1 to 5 carbon atoms, optionally 1 to 3 carbon atoms, excluding any substituents that may be present. Optionally the linker group group in L⁵ and/or L⁶ is selected from optionally substituted alkylene, optionally having from 1 to 10 carbons, excluding any substituents that may be present. Optionally, the linker group is a linker group of the formula —(CH₂)_{q}—, wherein q is 1 to 5, optionally 1 to 4, optionally 1 to 3. Optionally, the linker group in L⁵ is a linker group of the formula —(CH₂)_{q}—, wherein q is 1 to 5, optionally 1 to 4, optionally 1 to 3, preferably 2 or 3. Optionally, the linker group in L⁶ is a linker group of the formula —(CH₂)_{q}—, wherein q is 1 to 5, optionally 1 to 4, optionally 1 to 3, preferably 1 or 2. Optionally all of L⁵ in the formulae herein are the same as one another. Optionally all of L⁶ in the formulae herein are the same as one another.

X² is a group that binds to the lanthanide ion (i.e. a europium ion or a terbium ion) other than an optionally substituted phthalimide group and/or an optionally substituted phthalamate group. In an embodiment, X² is selected from —CO₂, —CO₂R⁶, —O, OR⁶, —NHR⁶, —C(═O)R⁶, —C(═O)N(R⁶)₂, —PO(O)₂, —PO(O)(OR⁶), —PO(OR⁶)₂, —SR⁶, —SOR⁶, —SO₂, —SO₂R⁶, —NHC(═O)R⁶, —NHC(═O)NHR⁶, —NHC(═S)NHR⁶, and Q

wherein each R⁶ is independently selected from H and an optionally substituted hydrocarbon group,

Q is a group selected from

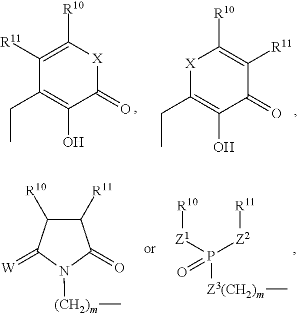

wherein R¹⁰ and R¹¹ are independently selected at each occurrence from: H and an optionally substituted hydrocarbon group;

m is 1-3;

W is two hydrogen atoms;

X is selected from O or NR⁷, wherein R⁷ is selected from H and optionally substituted hydrocarbon, e.g. optionally substituted alkyl, e.g. optionally substituted C₁ₜₒ₁₀ alkyl; and

Z¹, Z² and Z³ are independently selected from: O, NH, CH₂NH, and a direct bond.

R¹⁰ and R¹¹ may each independently be selected from: H and C₁-C₁₀ alkyl substituted with 0-5 R¹², C₃-C₁₀ cycloalkyl substituted with 0-5 R¹², C₁-C₁₀ fluoroalkyl substituted with 0-5 R¹², C₂-C₁₀ alkenyl substituted with 0-5 R¹², C₃-C₁₀ cycloalkenyl substituted with 0-5 R¹², C₂-C₁₀ fluoroalkenyl substituted with 0-5 R¹², and aryl substituted with 0-5 R¹², or, alternatively, R¹⁰ and R¹¹ may be taken together, with the atoms through which they are attached, to form a cyclic ring system, said ring system selected from: C₃-C₁₀ cycloalkyl substituted with 0-5 R¹², and aryl substituted with 0-3 R¹²;

each R¹² is independently selected from the group: COR¹³, C(═O)OR¹³, C(═O)N(R¹³)₂, PO(OR¹³)₂, OR¹³, and SO₂OR¹³;

R¹³ is independently selected at each occurrence from the group: H, and C₁-C₆ alkyl.

Preferably, each X² is selected from —CO₂ and —CO₂H. Optionally, in L⁶-X², the linker group in L⁶ is a linker group of the formula —(CH₂)_{q}—, wherein q is 1 to 5, optionally 1 to 4, optionally 1 to 3, preferably 1 or 2, and each X² is selected from —CO₂ and —CO₂H.

In a fourth aspect, the present invention provides a substrate having thereon or therein a complex according to the second aspect, wherein, if the substrate has therein a complex according to the second aspect, the substrate can absorb an aqueous liquid medium such that it can contact the complex. In an embodiment, the complex may be the first complex of the second aspect. In an embodiment, the complex may be the second complex of the second aspect.

The present inventors have found that it is possible to mark a substrate with a complex of the present invention, especially the first complex as described herein, which will indicate when the substrate has been subjected to a change in pH. This can be useful in many applications. For example, the substrate may be a security document having a complex of the present invention thereon or therein. If the complex is the first complex as described herein, the authenticity of the security document may be tested by measuring the luminescence of the complex, which may be before and/or after contacting the document with an aqueous liquid medium of an appropriate pH such that any phthalimide groups in the complex are hydrolysed to phthalamate groups.

In an embodiment, the substrate comprises a cellulosic material. The cellulosic material may be selected from a cotton-derived material and a wood-derived material. The cellulosic material may comprise paper. The paper may be wood-derived paper or cotton-derived paper. Cotton derived paper has been found to be more effective in the present invention that wood-derived paper. The substrate may comprise or be a security document, such as a bank note, certificate or legal document, such as a contract or will.

The substrate may have an image thereon comprising or consisting of the complex of the present invention, preferably the first complex as described herein. The image may comprise or be an indicia selected from one or more letters, numbers or recognisable symbols of any language.

In an embodiment, the complex may be present within the substrate, and the substrate can absorb an aqueous liquid medium such that it can contact the complex. The substrate may comprise or be a porous substrate. The porous substrate may comprise a water-absorbing material. Preferably, the water-absorbing material is not water-soluble, for example at a temperature of 20° C. and a pressure of 101.325 kPa. The water-absorbing material may, for example, comprise a gel. The gel may be a hydrogel. Hydrogels are known in the art. The hydrogel may be a plasticised three-dimensional matrix of cross-linked polymer molecules, and has sufficient structural integrity to be self-supporting even at very high levels of internal water content, for example having a water content of at least 50% by weight, optionally at least 80% by weight, optionally at least 100% by weight. The gel may comprise a polysaccharide gel, preferably a polysaccharide hydrogel, selected from carrageenan, xanthan gum, locust bean gum, konjac gum, gelatin, starch, methyl cellulose, carboxymethyl cellulose, ethyl cellulose, partially- or fully-deacetylated gellan, carob gum, agar, poly(glucuronic acid), poly(galacturonic acid), or a combination thereof. The hydrogel may be a protein-containing hydrogel, for example a hydrogel selected from fibrin and collagen. The hydrogel may be a synthetic hydrogel, for example a hydrogel selected from polyethylene glycol, polyvinyl alcohol, polyacrylamide, poly(N-isopropylacrylamide), poly(hydroxyethyl methacrylate) and other synthetic hydrogels, and combinations thereof.

The substrate may be used to detect a change in pH, particularly an increase in pH above about 9 to 10. Since the first complex of the present invention having at least one optionally substituted phthalimide will undergo a permanent change above pH 9 to 10, resulting in a permanent change in fluorescence, it can be used to detect if the substrate has at any point been exposed to a pH above about 9 to 10. For example, the substrate may be used in an environment where a high pH is indicative of detrimental conditions, such as a natural or man-made water-containing feature, including, but not limited to, rivers, lakes, seas, water outlets from industrial sites, water supply systems for supplying potable water, sewage systems, and the like. The substrate, e.g. the gel as described herein, may be located within a container that allows an aqueous liquid medium to pass through the container. The container may be a porous container, for example a container having porous walls. In an embodiment, the container may be formed from a mesh material. The container may be made from any suitable material, for example an organic or inorganic material. Preferably the container is made from a material that does not degrade over the range of pH that it may experience, e.g. a pH of from 2 to 11. The container may be made from a suitable polymeric material. Suitable polymeric materials are known in the art.

The substrate may be or comprise a food packaging. The food packaging comprises a material that is for use in packaging food and the complex of the present invention, particularly the first complex as described herein. The first complex as described herein can be used to indicate when the food packaging has been exposed to a high pH, i.e. a pH that can hydrolyse any optionally substituted phthalimide groups in the complex to optionally substituted phthalamate groups, e.g. a pH of above about 9 to 10. The substrate may comprise or be a container containing the complex of the present invention, the container being adapted to allow an aqueous liquid medium to pass from the exterior of the container to the interior to contact the complex of the present invention. The container may be present on an exterior part of a food packaging and/or an interior part of a food packaging. If the container is present on an exterior part of a food packaging it can detect if the exterior of the packaging has been exposed to a high pH, i.e. a pH that can hydrolyse any optionally substituted phthalimide groups in the first complex to optionally substituted phthalamate groups, e.g. a pH of above about 9 to 10. If the container is present on an interior part of a food packaging it can detect if an aqueous liquid medium having a high pH has entered the interior of the packaging, and possibly any food content therein, the high pH being a pH that can hydrolyse any optionally substituted phthalimide groups in the first complex to optionally substituted phthalamate groups, e.g. a pH of above about 9 to 10.

The first and/or second complex may be present in or on the substrate at a concentration of 0.01 mM or more, optionally a concentration of 0.05 mM or more, optionally a concentration of 0.1 mM or more, optionally a concentration of 0.5 mM or more, optionally a concentration of 1 mM or more, optionally a concentration of 1 mM or more, optionally a concentration of 2 mM or more, optionally a concentration of 3 mM or more, optionally a concentration of 4 mM or more, optionally a concentration of 4 mM or more, optionally a concentration of 5 mM or more.

In a fifth aspect, the present invention provides a kit comprising
a first complex according the second aspect and, separately,
a container containing an aqueous liquid medium at an appropriate pH, such that, when the liquid medium is contacted with the complex, at least one optionally substituted phthalimide group in the first complex is hydrolysed, to form a second complex. The first complex may be present in or on a substrate or in a composition, as described herein.

In a sixth aspect, the present invention provides a composition comprising a complex according to the second aspect and/or a compound according to the third aspect, and a carrier medium. In an embodiment, the complex may be the first complex of the second aspect. In an embodiment, the complex may be the second complex of the second aspect. The complex according to the second aspect, e.g. the first and/or second complex, may be present in the composition at a concentration of 0.01 mM or more, optionally a concentration of 0.05 mM or more, optionally a concentration of 0.1 mM or more, optionally a concentration of 0.5 mM or more, optionally a concentration of 1 mM or more, optionally a concentration of 1 mM or more, optionally a concentration of 2 mM or more, optionally a concentration of 3 mM or more, optionally a concentration of 4 mM or more, optionally a concentration of 4 mM or more, optionally a concentration of 5 mM or more.

The carrier medium may be liquid medium within which the complex or compound is dispersed, for example dissolved or suspended. The medium may be an aqueous liquid medium. The medium may comprise or be a gel, which may be as described herein.

In a seventh aspect, the present invention provides use of a first complex according to the second aspect for detecting a change in pH. In an embodiment, the complex may be the first complex of the second aspect. In an embodiment, the complex may be the second complex of the second aspect. If the complex is the first complex of the second aspect, the complex can be used to detect if there has been a change in pH that results in hydrolysis of any optionally substituted phthalimide group or groups in the complex to an optionally substituted phthalamate group or groups. The detection can involve detecting a change in the wavelength of maximum luminescence intensity, which will typically be different for a first complex of the invention and an analogous second complex of the invention (in which the phthalimide groups of the first complex have been hydrolysed to phthalamate groups).

If the complex is the first complex of the second aspect, the complex can be used to detect a change in pH. The luminescence intensity for a given wavelength (e.g. the wavelength of maximum luminescence intensity for the complex) typically varies with pH. Accordingly, the detection may involve detecting a change in luminescence intensity at a certain wavelength, e.g. the wavelength of maximum luminescence intensity for the complex.

In a eighth aspect, the present invention provides use of a complex according to the second aspect as a security marker. For example, the complex may be a first complex described herein that is present on a document or in or on a packaging as described above.

In a ninth aspect, the present invention provides use of a complex according to the second aspect as a molecular switch.

The complex according to the present invention may be used in or as a logic gate. The logic gate will typically have at least one output and at least one input. An output may be the occurrence of luminescence at a particular wavelength, for example the wavelength at which maximum intensity of luminescence occurs. If the complex displays luminescence at the particular wavelength, the output may be deemed ‘on’. If the complex does not display luminescence at the particular wavelength, the output may be deemed ‘off’.

The input for the logic gate may be selected from one or more of the following:
(i) the incidence on the complex of electromagnetic radiation having a wavelength at or below a particular threshold wavelength, wherein above the threshold wavelength, no luminescence will be displayed in the complex;
(ii) if the complex comprises one or more optionally substituted phthalamate groups, the pH being above a first level, wherein below said level all phthalamate groups have been protonated, resulting in dissociation of the lanthanide from the ligand, wherein no luminescence is displayed; such a first level may be from about pH 3 to about pH 4; and
(iii) the pH being below a second level, wherein above said level no luminescence is displayed; such a second level may be about pH 10 to about pH 11.

In an embodiment, the complex may be used in or as a logic gate having three inputs (i), (ii) and (iii) mentioned above. In an embodiment, the complex may be used in or as an AND gate having three inputs.

The first complex according to the present invention may be used in or as logic gates where the order of certain inputs must meet specific criteria for a positive output to be shown. The first complex may be used in or as an implication logic gate. For example, the first complex may be used in a logic gate and have a first input that results in the hydrolysis of the phthalimide groups to phthalamate groups, to form the second complex (e.g. changing the pH as described herein), which is followed by a second input, which may be illumination of light of appropriate radiation so that luminescence occurs, with the output being measurement of the wavelength of maximum luminescence, with a positive output being a wavelength characteristic of the second complex, and a negative output being a wavelength characteristic of the first complex. In a further embodiment, the first complex may be used in a logic gate and have a first input that results in the hydrolysis of the phthalimide groups to phthalamate groups, to form the second complex (e.g. changing the pH as described herein), which is followed by a second input, which is the lowering of pH to a pH of maximum luminescence (e.g. between a pH of between 4 to 7, e.g. about pH 6), with a third input being illumination of light of appropriate radiation so that luminescence occurs, with the output being measurement of the wavelength of maximum luminescence and intensity of maximum luminescence, with a positive output being a wavelength and intensity characteristic of the second complex at the pH of maximum luminescence, and a negative output being any other wavelength or intensity. Accordingly, the first complex may be used in concatenated logic gates and/or as a molecular lock system, e.g. a molecular keyboard lock system. Such systems are described in general in the art, for example in Strack et al, J. Am. Chem. Soc. 2008, 130, 4234-4235, which is incorporated herein by reference in its entirety.

The complex may be used in an electronic device having a means to control the input or each input, if more than one input, and a means to detect the output.

In a tenth aspect, the present invention provides use of a complex according to the second aspect as a metal ion sensor. In an embodiment, the complex may be the first complex of the second aspect. In an embodiment, the complex may be the second complex of the second aspect. The metal ion may be a metal ion other than a europium ion and terbium ion. In the tenth aspect, the complex may be used to detect the presence of and/or the concentration of the metal ion. The complex according to the second aspect and the metal ion being detected may be in a carrier medium, which may be as described herein. The carrier medium may be a liquid medium within which the complex is dispersed, for example dissolved or suspended. The liquid medium may be an aqueous liquid medium. The medium may comprise or be a gel, which may be as described herein. The use of the tenth aspect may involve contacting a complex according to the second aspect with a metal ion to be detected and measuring a change in luminescence of the complex, e.g. the luminescence intensity of the complex. The presence of the metal ion may be indicated by a drop in the luminescence intensity of the complex. The concentration of the metal ion may be determined from a known relationship between the concentration of the metal ion and the luminescence intensity of the complex according to the second aspect when in contact with the metal ion; the known relationship may be or may have been determined in a calibration step. Measuring the change in luminescence may include measuring a change in a value selected from: (i) the wavelength of maximum luminescence (e.g. for the complex of the first aspect), (ii) the intensity of luminescence at a predetermined wavelength, e.g. the wavelength of maximum luminescence (e.g. for the complex of the first aspect) and (iii) the luminescence lifetime (e.g. for the complex of the first aspect).

The metal ion may be in the (II) or (III) valence state. The metal ion may be selected from ions of metals of Group 2 of the Periodic Table (sometimes termed alkali earth metals) and ions of transition metals. The transition metals may be selected from, for example, Groups 3 to 12 of the periodic table. The transition metal may be selected from a first row transition metal, a second row transition metal and a third row transition metal.

The metal ion may be selected from, for example, copper (II), Fe (III), Fe (II), Ni (II), Co (II), Ca (II) and Zn (II). Preferably, the metal ion is selected from, for example, copper (II) and Fe (III).

The metal complexes of the present invention can be used to detect metal ions when they are at very low concentrations. The metal ion may be present, when contacted with the complex in the use of the tenth aspect (e.g. in a carrier medium), in a concentration of 1 mM or less, optionally 0.1 mM or less, optionally 0.01 mM or less, optionally 50 μM or less, optionally 1 μM or less, optionally from 1 mM to 1 μM, optionally from 0.1 mM to 1 μM, optionally from 0.01 mM to 1 μM. The metal ion may be present in concentration of 0.5 μM or more, optionally 1 μM or more.

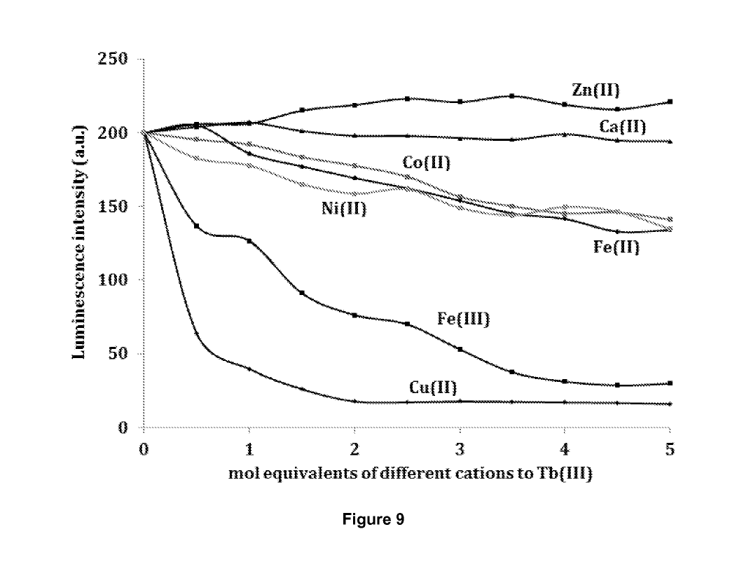

The complex according to the second aspect may be used to selectively detect a first metal ion in the present of the second metal ion. The present inventors have found that different ions affect the fluorescence intensity of the complex to different extents. This is illustrated for certain ions, for example, in FIG. 9, where Cu (II) has much greater effect in reducing the fluorescence intensity (quenching the intensity) than other ions.

In an embodiment, the complex according to the present invention may be used selectively in detecting copper (II) ions in micromolar range (for example at concentrations at or above 1 μM, optionally in the ranges from 1 mM to 1 μM, or other ranges stated above). The complex can also discriminate between Fe(II) and Fe (III) ions. For example, binding of the copper (II) complex is registered by quenching of the brightly fluorescent green Terbium complex.

Embodiments of the present invention will now be illustrated with reference to the drawings and following non-limiting Examples.

### EXAMPLES

### Example 1

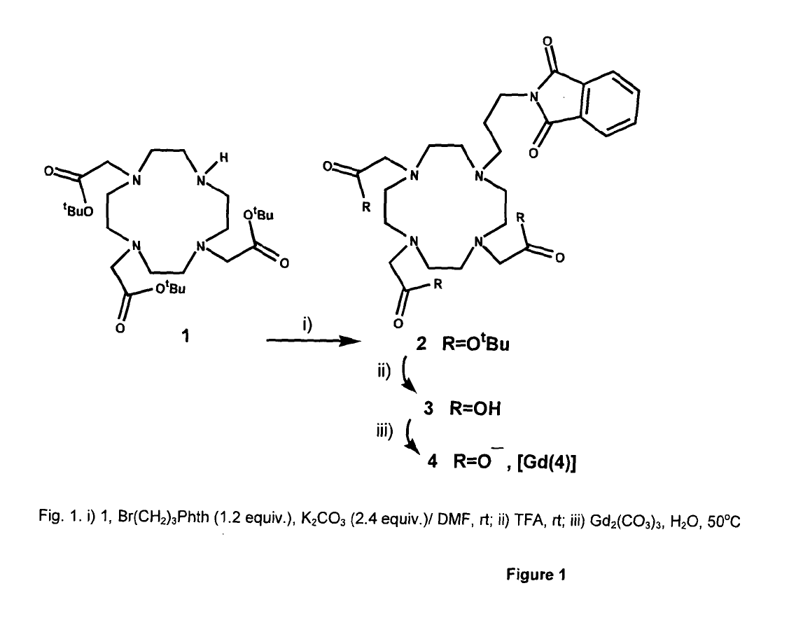

An example of an organic ligand for use in the present invention is 1-(3-[phthalimido]propyl-4,7,10-tris(carboxylmethyl)-1,4,7,10-tetraazacyclododecane (3). This compound was formed by the conjugation of the well-known macrocyclic moiety DO3A to a phthalimide chromophore via a propyl-bridge, as described in more detail below. In the following Example we show that a Tb³⁺ complex of the compound 3 displays exceptionally strong luminescence that can be switched on and off by further changes in pH. Also described is the corresponding Eu³⁺ system. An outline synthetic route to compound 3 is shown in FIG. 1.

Compound/ligand 3 was synthesised in two stages (FIG. 1), introducing in the first instance the propylphthalimido function through standard alkylation of DO3A-t-butyl ester (1) with N-(bromopropyl)phthalimide. This employed a K₂CO₃/DMF system at room temperature to give 2 as a hygroscopic oil. Selective deprotection of the DO3A t-butyl ester functions with retention of phthalimido functionality was achieved thereafter using trifluoroacetic acid at room temperature to generate ligand 3 in 14% yield (from 1). The corresponding Gd³⁺ complex [Gd(4)] was also synthesised and fully characterised.

Initial luminescence studies were focused on complexes formed by the phthalimide-containing system 4. The Eu³⁺ and Tb³⁺ complexes of 4 were prepared in situ in H₂O and D₂O (for example by adding an molar equivalent or more of a water soluble Eu³⁺ or Tb³⁺ salt, such as a Europium or Terbium halide, e.g. chloride, to an aqueous solution of the above-mentioned Gd³⁺ complex) and the pH/pD was initially adjusted to 6. Analysis of the UV spectrum of both the Eu³⁺ and Tb³⁺ complexes showed a peak centered around 298 nm. Upon excitation at this energy the characteristic but rather weak lanthanide-based emission was observed. Measurement of the phosphorescence lifetimes of the Eu(⁵D₀) and Tb (⁵D₄) levels in H₂O and D₂O indicated slightly differing behaviour for the two complexes: the number of coordinated water molecules was 0.27±0.3 and 0.98±0.3 for [Eu(4)] and [Tb(4)] respectively.

The luminescence was pH dependent: at low pH there was with significant diminution of the signal, due to protonation of the carboxylate moieties and subsequent decomplexation. However, at higher pH an unanticipated phenomenon was observed. Initial measurements indicated that at around pH 9 the luminescence was sharply switched off. Re-measurement of the UV spectrum under these conditions indicated that the 298 nm absorbance had disappeared, and was replaced with an absorption centered at around 272 nm (see Table 1 below). Excitation of the terbium complex at this energy level yielded a much brighter luminescence—maximal at pH 6, the quantum yield increasing from 5% to 32% for the new species [Tb(5)]⁻.

TABLE 1
shows the Luminescence lifetimes (T) and calculated inner sphere
hydration numbers (q) for the complexes under study

| | λ_{exc} | τ_{H2O} | τ_{D2O} | q |
|---|---|---|---|---|
| Complex | (nm) | (ms) | (ms) | (±0.3) |
| [Eu(4)] | 298 | 0.97 | 1.80 | 0.27 |
| (pH/D 6) | | | | |
| [Tb(4)] | 298 | 1.50 | 2.44 | 0.98 |
| (pH/D 6) | | | | |
| [Eu(5)]⁻ | 272 | 0.96 | 1.83 | 0.29 |
| (pH/D 6) | | | | |
| [Tb(5)]⁻ | 272 | 2.26 | 2.78 | 0.10 |
| (pH/D 6) | | | | |

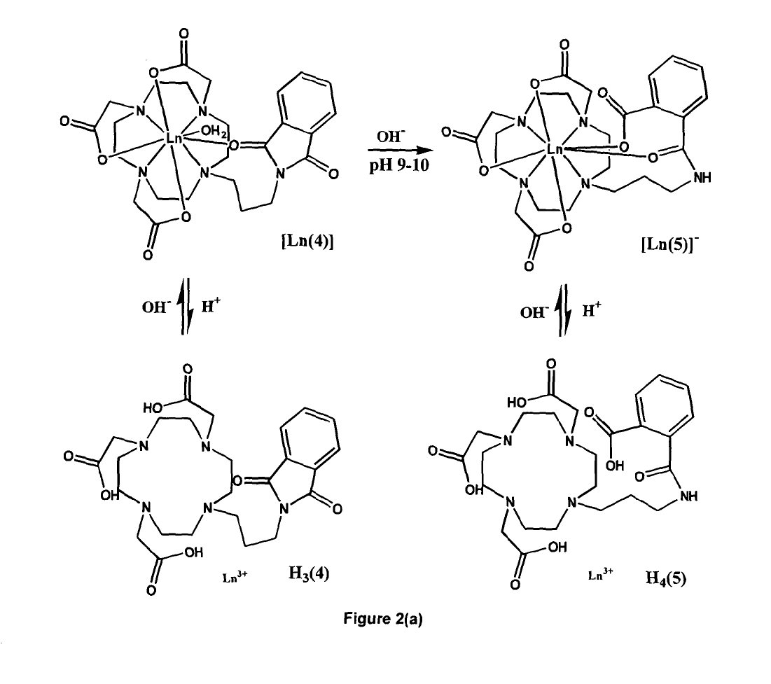

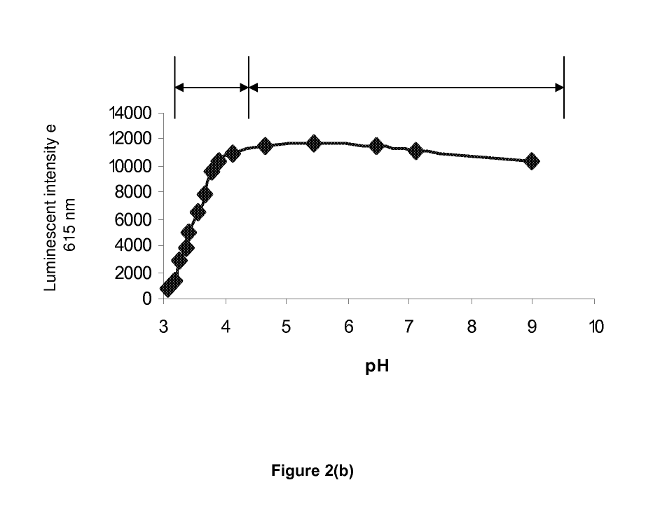

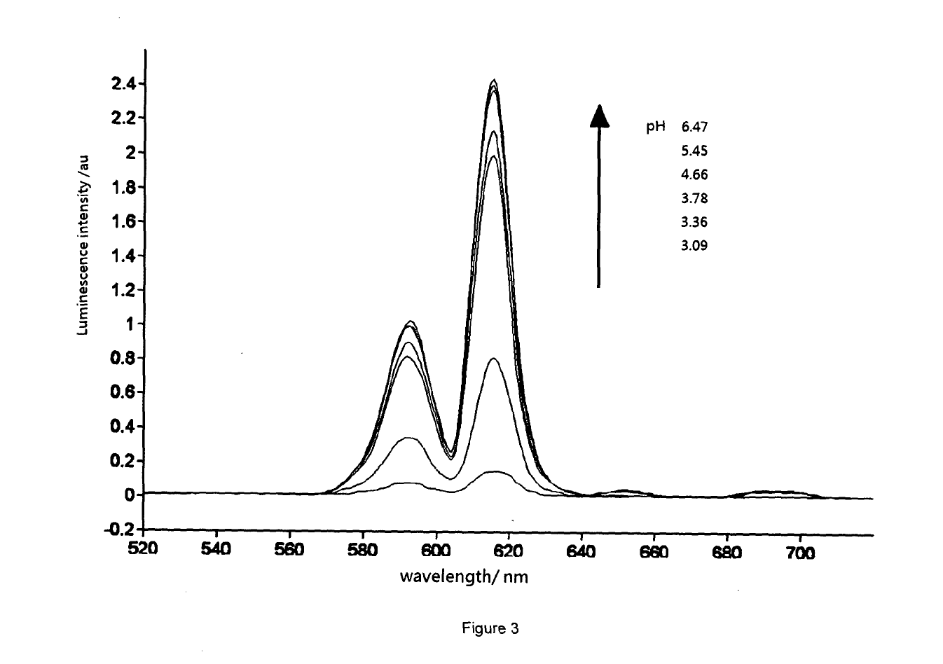

FIG. 2(a) shows the phthalimido-phthalamate hydrolysis; FIG. 2(b) shows Luminescence responses of [Eu(5)]⁻ to pH variation at 25° C., excitation=272 nm; FIG. 2(c) shows emission spectra of [Eu(5)]−. Conditions are the same as (b).

The relative increase in luminescence lifetime observed on transition from terbium complex [Tb(4)] to [Tb(5)]⁻ was significantly greater in H₂O than D₂O (see Table 1). Concomitantly, the calculated number of coordinated water molecules (q) was found to drop from 0.98 to 0.1 at pH 9. The later feature can be explained by the facile hydrolysis that the phthalimido moiety is known to undergo between pH 9 and 10 yielding a phthalamate 5 (FIG. 2(a)). Without being bound by theory, we believe that the higher denticity of the phthalamate-containing species, [Tb(5)]⁻, obviates the need for a coordinated water molecule, reducing the q value and enhancing the quantum yield due to a reduction in non-radiative relaxation. The equivalent Eu³⁺ system however seems relatively unaffected by this transformation, presumably as a result of having no bound water molecules initially (within experimental error). Similar luminescence lifetimes for the 4 and 5 forms were displayed as a result.

The new complexes, [Ln(5)]⁻ (Ln=Eu, Tb), then displayed reversible pH dependent behaviour. The luminescence is essentially “on” between pH 10 and 4, whereafter it was rapidly turned “off” between pH 3 and 4 (FIG. 2 (b) and (c)) presumably as a result of protonation of the carboxylate moieties and subsequent decomplexation (FIG. 2 (a)).

To summarise: [Ln(4)], as illustrated in FIG. 2(a) can be thought of as being locked in a dormant (“off”) state until being irreversibly activated by a mild change in pH, i.e. a pH of above 9-10, at which point the phthalimide groups are hydrolysed to phthalamate groups. Thereafter, it functions as a sensitive and reversible acidic pH sensor.

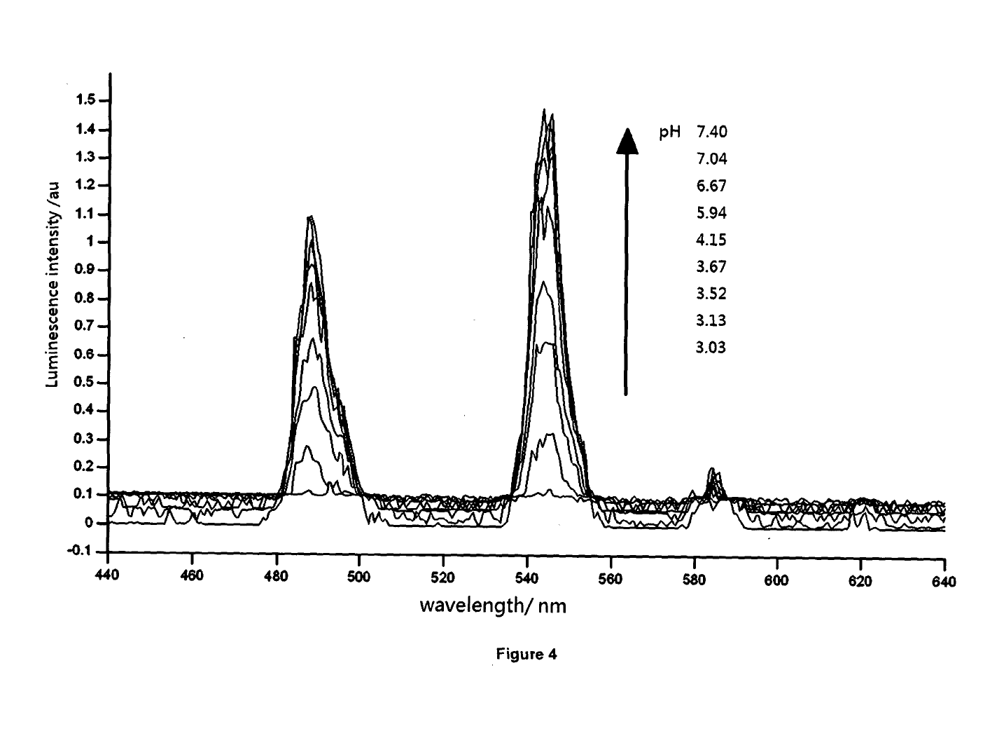

The switching off the luminescence in species' [Ln(5)]⁻ is remarkably rapid. For example the Eu³⁺ complex [Eu(5)]⁻ (FIG. 2 (b)) lost around 90% of its luminescent intensity within one pH unit, a figure comparable with a recently reported “digital” pH sensor (see S. Uchiyama, Y. Makino, Chem. Commun. 2009, 2646). The results of a the effect of pH on an analogous [Tb(5)]⁻ complex can be seen in FIG. 4. The basis of this phenomenon can be accounted for by the comparative length of the propyl-bridge: the phthalamate moiety becomes distal from the Ln centre on protonation, leading to inefficient energy transfer. This sharply defined switching could be an invaluable characteristic in molecular computation. Additionally the system also has the added advantage of exhibiting a long lifetime, allowing it to be used in a time-gated manner, leading to improved signal to noise ratios relative to a purely organic pH sensor.

In addition we have established that the unhydrolysed complex [Ln(4)] can operate as a “password protected” molecular switch. There are three inputs for the password protected molecular switch:
1. Addition of base (B) so that resulting mixture has a pH between 9 and 10;
2. Addition of Acid (A) so that resulting mixture has a pH ca. 6; and
3. Excitation of the molecule using UV light (U) frequency ca. 270 nm.

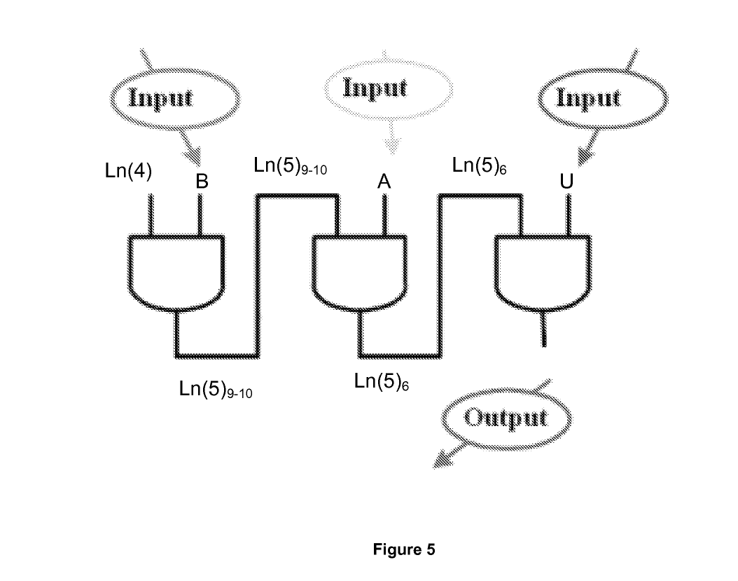

The system behaves as an implication logic gate similar to that illustrated in JACS, 2008, 130, 4234-4235. The implication logic gate, and its inputs and outputs are illustrated in FIG. 5. In FIG. 5, Ln(4) is the un-hydrolyzed complex (a phthalimide complex); Ln(5)₉₋₁₀ is the hydrolyzed complex (the resulting phthalmate complex) in a medium with pH ca. 9 and 10; Ln(5)₆ is the hydrolyzed complex in a medium ca. pH 6.

This system essentially acts as a keypad lock. The inputs must be supplied to in the correct order to give a positive output—the maximal terbium- or Europium-based luminescence.

Table 2 is a truth table for the molecular keypad lock system upon varying the order of Input Signals A, B, and U.

TABLE 2

| Input 1 | Input 2 | Input 3 | Output |
|---|---|---|---|
| B | A | U | 1 |
| A | B | U | 0 |
| U | A | B | 0 |
| U | B | A | 0 |
| B | U | A | 0 |
| A | U | B | 0 |

In conclusion we have demonstrated that lanthanide complexes based on the ligand; 1-(3-[phthalimido]propyl-4,7,10-tris(carboxylmethyl)-1,4,7,10-tetraazacyclododecane, are multifunctional; i) as sensitive pH sensors after hydrolysis and, ii) as implication molecular logic gates to three inputs using Tb³⁺ or Eu³⁺ luminescence as an output.

### Experimental Procedures for Example 1

### General

NMR spectra were recorded at ambient temperature, on a Bruker Avance-500 (¹H, ¹H—H COSY, 500.13 MHz; ¹³C, 135-DEPT, 125.77 MHz). All ¹³C spectra are ¹H broadband decoupled. Chemical shifts (5) are expressed in ppm and J values are given in Hz. ¹H and ¹³C NMR spectra were referenced internally to Me₄Si apart from those carried out in D₂O, where TSP-d₄ was used. Mass spectrometry was performed using a Kratos Profile HV3 mass spectrometer in “Liquid Secondary Ionisation Mass Spectrometry” mode (employing glycerol as a matrix) or a MassLynx 4.0 SP4, SCN 519 Q-TOF mass spectrometer employing an electrospray source in positive ion (ES⁺) mode. Melting points were obtained on an Electrothermal Eng. Ltd. digital melting point apparatus, and are uncorrected. A Carlo Erba 1108 Elemental Analyser was used for C, H and N microanalyses. TLC was performed on pre-coated silica plates (Whatman Al Sil G/UV, 250 μm layer) in the solvent systems stated. Column chromatography was performed over Sorbsil C60 silica gel (60 μm {MPD}), Aldrich silica gel (Merck grade 10180, 63-200 μm particle diameter) or Uetikon C-Gel C-560 ACT silica gel (40-63 μm particle diameter). Reagents were used as purchased. Solvents DMF, diethyl ether and methanol respectively were either used as the HPLC grade material or dried and stored in accordance with established procedures.¹ All other solvents were used as purchased.

### Syntheses

1,4,7-Tris(carboxymethyl-t-butyl-ester)-1,4,7,10-tetraazacyclododecane, HBr salt (1, DO3A-tert-butyl ester, HBr salt) was prepared as a white solid from cyclen according to the method of Schultze and Bulls;² N-(3-Bromopropyl)phthalimide was prepared according to the method of Salzberg and Supniewski;³ mp 73-76° C. [lit. 74-75° C.]; (Found: C, 49.23; H, 3.55; N, 5.16. Calc'd. for C₁₁H₁₀NO₂Br: C, 49.25; H, 3.73; N, 5.22%.): δ_{H}(CDCl₃): 2.21-2.33 [2H, m, CH₂CH₂CH₂]; 3.43 [2H, t, J 6.7, CH₂N]; 3.84 [2H, t, J 6.7, CH₂Br]; 7.72-7.80 [2H, m, m-ArH]; 7.83-7.92 [2H, m, o-ArH]; δ_{C}(CDCl₃): 29.82, 31.63, 36.71 [CH₂'s]; 123.30, 134.05 [o,m-ArC]; 131.99 [ipso-ArC]; 168.20 [C═O's]; MS (LSIMS): 268, 270 (100, 85% resp., [MH]⁺).

Respective correlations are denoted “resp.” Room temperature is denoted by “rt”. Major and minor multiplets are denoted “maj” and “min” respectively, shoulders are denoted “sh”, and assignments made on basis of an ¹H—H COSY spectrum are denoted as such. Phthalimido functions are denoted “Phth” and aromatic C and H's therein are denoted “o, m, ipso” relative to imido-substituted positions.

### 1-(3-[phthalimido]propyl)-4,7,10-tris(carboxymethyl)-1,4,7,10-tetraazacyclododecane (3)

An anhydrous DMF suspension (10 cm³) of DO3A-tert-butyl ester HBr salt 1 (1.49 g, 2.5 mmol), N-(3-bromopropyl)phthalimide (0.80 g, 3.0 mmol) and anhydrous K₂CO₃ (0.83 g, 6.0 mmol) was vigorously stirred under anhydrous conditions at rt for 6 days. The mixture was then decanted into dichloromethane (250 cm³), washed with deionised water (5×100 cm³) and sat'd brine (2×100 cm³), and dried over MgSO₄. Evaporation in vacuo yielded a yellow oil which was subjected to column chromatography (eluent—CH₂Cl₂/MeOH 5:1 v/v; desired fractions, ¹H-NMR; TLC-R_{f} 0.65), leaving the 1-(3-[phthalimido]propyl)-4,7,10-tris(carbo-[1,1-dimethyl]ethoxymethyl)-1,4,7,10-tetraazacyclododecane intermediate (2) as a hygroscopic oil which was subjected to the deprotection procedure described below: δ_{H}(CDCl₃): 1.41, 1.42, 1.44, 1.46 [27H, 4×s, CH₃'s (^{t}Bu)]; 1.83 [2H, m, CH₂CH₂CH₂ (linker)]; 1.90-3.60 [24H, br. m, PhthNCH₂ (linker), and 11×NCH₂ (DO3A segment)]; 3.68 (maj), 3.80 (min) [2H, 2×t, CH₂N (linker)]; 7.74-7.76 and 7.83-7.87 [2H, 2×m, ArH (Phth)]; also 5.31 [˜0.8H, 0.4×CH₂Cl₂]; δ_{C}(CDCl₃): 25.71 [CCH₂C (linker)]; 27.82, 27.92, 28.10, 28.14 [CH₃'s, ^{t}Bu]; 35.51, 36.11 [NCH₂'s (linker)]; ˜48.70, 50.33, 50.45, 51.83, 52.51, 53.46, 55.76, 56.76br. [NCH₂'s (DO3A segment)]; 81.76, 81.91, 82.34, 82.74 [CMe₃'s, ^{t}Bu]; 123.26, 123.43, 123.66, 125.29, 128.22, 129.03, 134.14, 134.18 [o,m-ArC]; 131.91, 131.93 [ipso-ArC]; 168.15, 169.79, 170.16, 172.78 [C═O's]. A stirred chloroform solution (15 cm³) of 2 was charged with trifluoroacetic acid (20 cm³) and the reaction mixture was stirred under anhydrous conditions at rt for 4 h. The mixture was evaporated in vacuo and the residue was azeotroped twice with chloroform. Dropwise addition of an acetone (3 cm³) solution of the residue to diethyl ether (100 cm³) yielded crude solid and repetition of this precipitation technique, followed by trituration of the separated solid in diethyl ether, yielded 3 as a cream-white solid (359.8 mg, 14% from 1): mp 135-140° C.: (Found: C, 42.58; H, 4.52; N, 8.15. Calc'd. for C₂₅H₃₅N₅O₈.3CF₃COOH: C, 42.49; H, 4.38; N, 8.03%): δ_{H}(D₂O, solvent suppression): 2.15 [2H, br s., CH₂CH₂CH₂]; 3.08, 3.14, 3.36, 3.41, 3.45, 3.49, 3.59, 3.68, 3.85 [24H, 9×br. s, PhthNCH₂ (linker), and 11×NCH₂ (DO3A segment)] in which 3.31-3.41sh. [2H, PhthNCH₂ (linker)]; 3.71 [2H, t, NCH₂ (linker)]; 7.76 [4H, s, ArH (Phth)]; also 1.38 and 2.21 [2×s, trace, CH₃]; δ_{C}(CDCl₃): 25.48 [CCH₂C (linker)]; 33.23, 37.94 [NCH₂'s (linker)]; 51.50, 52.76, 54.18, 54.82, 56.39, 59.05 [NCH₂'s (DO3A segment)]; 118.18, 120.50, 122.82 [CF₃]; 126.39, 134.06, 137.82 [ArC, (Phth)]; 165.80, 166.09, 173.21, 173.28 [C═O's]; also 30.28; ES-MS: 534.3 (1%, [MH⁺], 332.1 (14), 331.1 (31), 301.1 (13), 300.1 (30), 157.1 (100).

### 1-(3-[phthalimido]propyl)-4,7,10-tris(carboxymethyl)-1,4,7,10-tetraazacyclododecane, Gadolinium complex [Gd(4)]

An aqueous suspension (5 cm³) of ligand 3 (61.0 mg, 0.07 mmol) and Gd₂CO₃ (17.2 mg, 0.035 mmol) was stirred at 50° C. for 24 h, filtered, and the filtrate was evaporated in vacuo with subsequent azeotropic removal of residual water (absolute ethanol: 2×25 cm³). Addition of acetone

(20 cm³) yielded a precipitate which was isolated on a filtration apparatus and washed with diethyl ether (2×20 cm³). Air-drying on the apparatus left [Gd(4)] as a cream-white solid (33.7 mg, 12%): mp 192-193° C.: (Found: C, 43.50; H, 5.12; N, 10.17. Calc'd for C₂₅H₃₂N₅O₈Gd.½H₂O: C, 43.09; H, 4.77; N, 10.05%); MS (ES⁺): 688.9483 (22, [MH]⁺. calc'd—688.8084); 687.9604 (18); 535.0645 (100, [Ligand H]⁺. calc'd—534.5822); 534.0378 (88%).

### Luminescent Studies

Absorption spectra were recorded on a Perkin Elmer EZ301 Spectrophotometer UV/Vis spectrometer with luminescence cells with a path length of 0.2 cm. Luminescence lifetime measurements were recorded on a Perkin-Elmer LS50B spectrometer at 298 K with no external regulation. The phosphorescent lifetime was measured by recording the decay at the maximum of the emission spectra. The signals were analysed to be single-exponential. The instrument settings were as follows: cycle time=200 ms, a flash count of 5, a gate time of 5 ms, integration time of 1 s and excitation and emission slit widths of 2.5 nm. The number of coordinated water molecules present in solution q were determined from lifetime measurements by using the equation of Parker and co-workers (q=A_{Ln}(1/τH₂O-1/τD₂O-α_{Ln}) with Aₘ=5 ms, A_{Eu}=1.2 ms, α_{Tb}=0.06 ms⁻¹, and α_{Eu}=0.25 ms⁻¹).⁴

Quantum yields Q have been calculated by using the equation Qₓ/Qᵣ=Aᵣ(\tilde{ν})·nₓ²·Dₓ/Aₛ(\tilde{ν})·nᵣ²·Dᵣ, in which x refers to the sample, r to the reference, A to the absorbance, \tilde{ν} to the excitation wavenumber used, n to the refractive index, and D to the integrated emitted intensity. The tris(dipicolinate) complexes [Tb(dpa)₃]³⁻ (Φ=26.5%, 6.5×10⁻⁵ M in tris buffer 0.1 M) was used as references for the determination of the quantum yields of the Tb-containing samples.⁵ The consistency of data was checked by measuring the quantum yield of the tris(dipicolinate) complexes against rhodamine B (Q_{abs}=65% in absolute ethanol).⁶

### REFERENCES

1. A. I. Vogel, Vogel's Textbook of Practical Organic Chemistry (5^{th} Edn); B. S. Furniss; A. J. Hanniford; P. W. G. Smith; A. R. Tatchell, Eds.; Longman Scientific and Technical, co-published with John Wiley and Sons, New York, 1989.
2. L. Schultze and A. R. Bulls, WO Pat 96/28433 (19 Sep. 1996).
3. P. L. Salzberg and J. V. Supniewski, Org. Synth. Coll., 1941, 1, 119-121.
4. A. Beeby, I. M. Clarkson, R. S. Dickens, S. Faulkner, D. Parker, L. Royle, A. S. de Sousa, G. J. A. Williams, M. Woods, J. Chem. Soc. Perkin Trans. 2. 1999, 493-503
5. A.-S. Chauvin, F. Gumy, D. Imbert. J.-C Bünzli, Spectrosc. Lett. 2004, 37, 517-532; A.-S. Chauvin, F. Gumy, D. Imbert. J.-C Bünzli, Spectrosc. Lett. 2007, 40, 193-193
6. R. F. Kubin, A. N. Fletcher, J. Fluorescence, 1982, 27, 455-462

### Example 2

Described below are synthetic procedures for a selection of compounds that can be used in the complexes of the present invention.

### 1-(N-[phthalimide]ethyl)-4,7,10-triacetic acid-1,4,7,10-tetraazacyclododecane

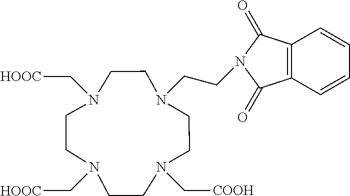 [SMILES: O=C(O)CN1CCN(CCN2C(=O)c3ccccc3C2=O)CCN(CC(=O)O)CCN(CC(=O)O)CC1]

DO3A-tert-butyl ester HBr salt (638.8 mg, 1.01 mmol) was dissolved in methanol (10 cm³) KOH (86.7 mg, 1.55 mmol) solution. The mixture solution was evaporated in vacuo and filtered a dichloromethane solution (20 cm³) before evaporating again, leaving a colorless syrup. To this was added anhydrous K₂CO₃ (182.3 mg, 1.25 mmol) and N-2(bromoethyl)phthalimide (325.5 mg, 1.28 mmol) followed by anhydrous DMF (10 cm³). This mixture solution was vigorously stirred at room temperature under anhydrous condition for 5 days. The solution was then evaporated in vacuo and the residual material re-dissolved in dichloromethane (70 cm³), washed with deionised water (4×50 cm³) and sat'd NaCl (50 cm³), and dried over Na₂SO₄. Evaporation in vacuo yielded a straw oil which was subjected to column chromatography (eluent—CH₂Cl₂/MeOH 7:1 v/v; desired fractions, R_{f} 0.64). Thereafter, the collected fractions were combined and the solvents were evaporated in vacuo. The residue was dissolved in a stirred chloroform solution (10 cm³) which was charged with trifluoroacetic acid (10 cm³) and the reaction mixture was stirred under anhydrous conditions at room temperature overnight. The mixture was evaporated in vacuo and dropwise addition of a methanol (1 cm³) solution of the residue to diethyl ether (50 cm³) yielded crude solid and repetition of this precipitation technique, yielded off-white solid (36.7 mg, 7.1%)

¹H(CD₃OD): 3.16, 3.17, 3.35, 3.53, 3.65, 3.68, 3.74, 3.94 [22H, 11×NCH₂ (DO3A segment)]; 3.44-3.48sh. [2H, PhthNCH₂ (linker)]; 4.17 [2H, t, NCH₂ (linker)]; 7.83 [4H, s, ArH (Phth)]; ¹³C(CD₃OD): 33.54, 37.75 [NCH₂'s (linker)]; 50.17, 52.90, 54.04, 54.15, 55.89, 64.11[NCH₂'s (DO3A segment)]; 124.42, 133.28, 135.73 [ArC, (Phth)]; 162.36, 169.68 [C═O's]. ES-MS: 520.1511 ([MH⁺]).

### 1,4-bis-(N-[phthalimide]propyl)-7,10-triacetic acid-1,4,7,10-tetraazacyclododecane

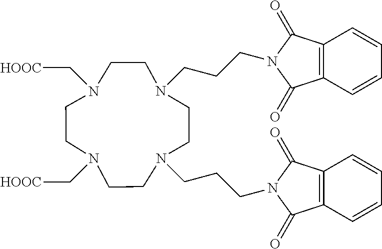 [SMILES: O=C(O)CN1CCN(CCCN2C(=O)c3ccccc3C2=O)CCN(CCCN2C(=O)c3ccccc3C2=O)CCN(CC(=O)O)CC1]

A acetonitrile (50 cm³) solution of DO2A-tert-butyl ester HBr salt (1.00 g, 2.16 mmol), N-(3-bromopropyl)phthalimide (1.66 g, 5.85 mmol), triethylamine (3.30 g, 32.58 mmol) and anhydrous K₂CO₃ (0.20 g, 1.45 mmol) was stirred under anhydrous conditions at 60° C. for 5 days. The mixture was then decanted into dichloromethane (100 cm³), washed with deionised water (3×80 cm³), and dried over MgSO₄. Evaporation in vacuo yielded a brown oil which was subjected to column chromatography (eluent—CH₂Cl₂/MeOH 10:1 v/v; desired fractions, R_{f} 0.78). Thereafter, the collected fractions were combined and the solvents were evaporated in vacuo. The residue was dissolved in a stirred chloroform solution (25 cm³) which was charged with trifluoroacetic acid (25 cm³) and the reaction mixture was stirred under anhydrous conditions at room temperature for 4 h. The mixture was evaporated in vacuo and the residue was re-dissolved in chloroform (25 cm³) and trifluoroacetic acid (25 cm³) solution. The solution was evaporated in vacuo, the residue in an acetone (1.5 cm³) solution was then diluted by diethyl ether (100 cm³). This suspension solution was filtered on Buchner apparatus and the residue was dried over the vacuum for further 30 mins to yield a off-white solid (362.7 mg, 11%).

¹H(CD₃OD): 2.14 [4H, br s., CH₂CH₂CH₂]; 3.06, 3.16, 3.44, 3.48, 3.51, 3.61 [20H, 10×NCH₂ (DO3A segment)]; 3.31-3.44 sh. [4H, PhthNCH₂ (linker)]; 3.75 [4H, t, NCH₂ (linker)]; 7.80 [8H, s, ArH (Phth)]; ¹³C(CD₃OD): 25.21 [CCH₂C (linker)]; 36.62[NCH₂'s (linker)]; 51.15, 51.53, 52.92, 66.94[NCH₂'s (DO2A segment)]; 124.27, 133.38, 135.49 [ArC, (Phth)]; 169.94[C═O's]. ES-MS: 663.3961 ([MH⁺])

### 1,4,7-tris-(N-[phthalimide]propyl)-10-acetic acid-1,4,7,10-tetraazacyclododecane

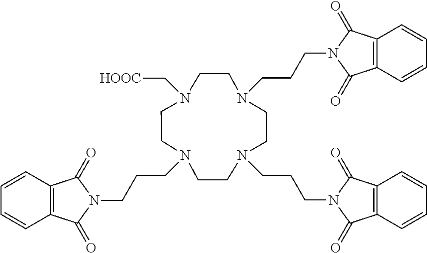 [SMILES: O=C(O)CN1CCN(CCCN2C(=O)c3ccccc3C2=O)CCN(CCCN2C(=O)c3ccccc3C2=O)CCN(CCCN2C(=O)c3ccccc3C2=O)CC1]

A four-neck pear-shaped flask (100 cm³) was fitted with a dropping funnel, reflux condenser, nitrogen bubbler and thermometer was charged with cyclen (0.82 g, 4.78 mmol), and fine K₂CO₃ (0.66 g, 4.78 mmol) and the suspension was heated up to 50-60° C., at which time, a solution of tert-butyl bromoacetate (0.32 g, 1.59 mmol) in dry acetonitrile (10 cm³) was added dropwise over a period of 15 mins. Thereafter the suspension was heated at 55-60° C. under nitrogen condition for 15 h, filtered and the filtrate was evaporated in vacuo to leave colorless oil. This crude compound was purified by column chromatography (CH₂Cl₂/MeOH/0.88NH₃(aq) 10:5:1 v/v/v; desired fractions, R_{f} 0.60). The collected fractions were combined and the solvents were evaporated in vacuo. The residue (0.3558 g, 1.24 mmol) and N-3(bromopropyl) phthalimide (1.05 g, 3.92 mmol) were dissolved in DMF (10 cm³). This stirred at room temperature as K₂CO₃ (0.5673 g, 1.24 mmol) was added. The mixture solution was stirred for further 12 days at room temperature. The mixture was then decanted into dichloromethane (150 cm³) and washed by deionised water (6×100 cm³) and saturated brine (100 cm³). The organic phase was dried over MgSO₄, and evaporated in vacuo to a yellow oil, followed by purification through column chromatography (CH₂Cl₂/MeOH/8: 1 v/v; desired fractions, R_{f} 0.65). The fractions were combined and evaporated in vacuo, the residue was re-dissolved in dichloromethane (5 cm³) and then trifluoroacetic acid (10 cm³) wad added, the mixture solution was stirred for 4.5 h under nitrogen condition at room temperature. The reaction mixture was then evaporated in vacuo, the residue was re-dissolved in acetone (2.5 cm³) and this was pipetted into vigorously stirred diethyl ether (20 cm³). The precipitate was isolated on a scinter-glass apparatus, washed by diethyl ether (2×5 cm³) and air dried to yield the powder product. (85.2 mg, 7.1%).

¹H(CD₃OD): 1.80, 1.94, 2.14 [6H, br m's, CCH₂C (linkers)]; 2.35-4.20 [28H, br. m's, 6×NCH₂ (linkers) and 8×NCH₂ (cyclen ring)]; 7.70-7.95 [12H, ArH (3×Phth)]; ¹³C(CD₃OD): 23.99, 26.39, 28.81 [CCH₂C (linker)]; 35.59, 35.76, 35.92, 36.11, 36.73, 36.93 [NCH₂'s (linker)]; 46.69, 50.74, 50.97, 51.51, 52.85, 53.12, 54.08, 54.77, 55.40 [NCH₂'s (cyclen ring)]; 124.13, 124.16, 124.21, 124.24, 124.30, 124.40, 135.32, 135.43, 135.44, 135.46, 135.51 [o,m-ArC]; 133.33, 133.37 [ipso-ArC]; 169.84, 169.88, 169.92, 169.97, 175.49 [C═O's]. ES-MS: 793.5 ([MH⁺]).

### 1,4,7,10-tetra-(N-[phthalimide]propyl)-1,4,7,10-tetraazacyclododecane

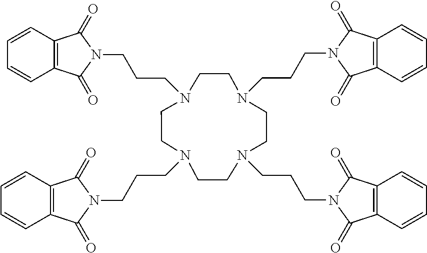 [SMILES: O=C1c2ccccc2C(=O)N1CCCN1CCN(CCCN2C(=O)c3ccccc3C2=O)CCN(CCCN2C(=O)c3ccccc3C2=O)CCN(CCCN2C(=O)c3ccccc3C2=O)CC1]

A acetonitrile (50 cm³) solution of cyclen (515.6 mg, 3 mmol), triethylamine (6.0724 g, 60.12 mmol) and anhydrous K₂CO₃ (301.1 mg, 1.8 mmol) was stirred under anhydrous conditions at 60° C. N-(3-bromopropyl)-phthalimide (4.8208 g, 16.97 mmol) in acetonitrile (20 cm³) solution was then dropwised into the mixture solution. The mixture solution was stirred between 60˜65° C. for 7 days. Thereafter the suspension solution was filtered by Buchner apparatus. The filtrate was then evaporated in vacuo, followed by re-dissolved in dichloromethane (100 cm³) and washed by deionised water (3×100 cm³), dried over anhydrous MgSO₄. The residue was dissolved in methanol (3 cm³), diluted by deionised water (7 cm³). The brown precipitate oil was isolated and dissolved in minimum amount of chloroform, diluted by diethyl ether (50 cm³), leaving overnight. The final suspension was filtered by Buchner apparatus and yielded straw powder (288.3 mg, 10.4%)

¹H(CDCl₃): 1.77 [8H, br s., CH₂CH₂CH₂]; 2.54, 2.62, 2.64, 2.80, 2.82, 2.93, 3.04 [24H, 8×NCH₂ cyclen, 4×NCH₂ (linker)]; 3.80, 3.76 [8H, PhthNCH₂ (linker)]; 7.65-7.80 [16H, br, s, ArH (Phth)]; ¹³C(CDCl₃): 26.94 [CCH₂C (linker)]; 36.15 [NCH₂'s (linker)]; 49.31, 50.52, 52.39 [NCH₂'s of cyclen)]; 123.05, 131.88, 133.95 [ArC, (Phth)]; 168.26 [C═O's]. ES-MS: 921.5619 ([MH⁺])

### Example 3

In this Example, the inventors demonstrate the effectiveness of terbium complexes according to embodiments of the present invention as security markers on sample banknote paper.

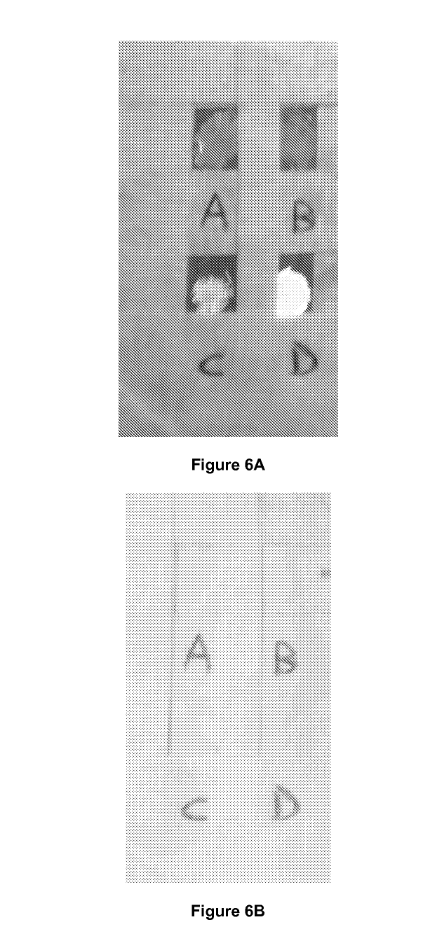

In this experiment, sample banknote paper was provided, and various complexes, at a certain pH were placed at certain locations as illustrated in FIG. 6B. The banknote paper was then illuminated with UV radiation and a photograph of the banknote paper taken—this photograph is shown in FIG. 6A

The various complexes and their locations (a to d) are described below.
a. Terbium(III) chloride aqueous solution, 5 mM
b. DO3A-phthalimide in water, 5 mM
c. Terbium(III) DO3A-phthalimide complex, 2.5 mM at pH 4
d. Terbium(III) DO3A-phthalimide complex, 1.25 mM at pH 9

As can be seen in the Figure, the Terbium complexes according to the present invention (locations c and d) have a far greater luminescence intensity than the terbium chloride complex (site a) or the non-metal containing DO3A-phthalimide compound (site b). The luminescence intensity at site d can be seen to have the highest luminescence intensity.

### Example 4

In this Example, the inventors demonstrate the effectiveness of Europium complexes according to embodiments of the present invention as security markers on sample banknote paper.

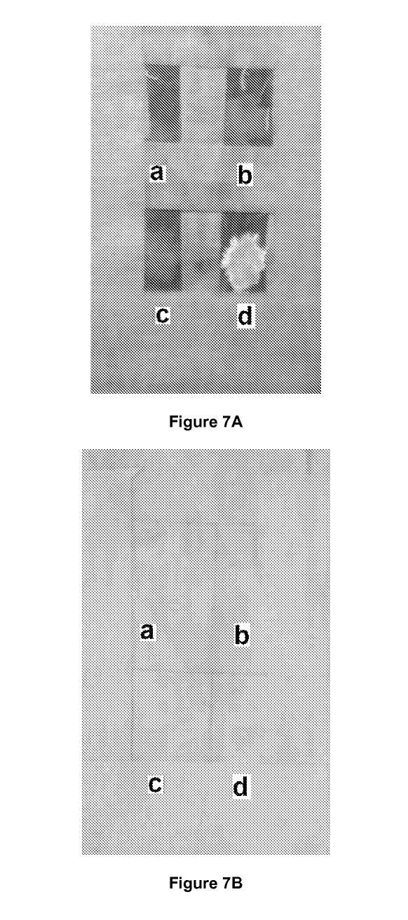

In this experiment, sample banknote paper was provided, and various complexes, at a certain pH, were placed at certain locations as illustrated in FIG. 7B. The banknote paper was then illuminated with UV radiation and a photograph of the banknote paper taken—this photograph is shown in FIG. 7A

The various complexes and their locations (a to d) are described below.
a. Europium(III) chloride aqueous solution, 5 mM
b. DO3A-phthalimide in water, 5 mM
c. Europium(III) DO3A-phthalimide complex, 2.5 mM at pH 4
d. Europium(III) DO3A-phthalimide complex, 1.25 mM at pH 9

As can be seen in the Figure, the Europium complexes according to the present invention (locations c and d) have a far greater luminescence intensity than the Europium chloride complex (site a) or the non-metal containing DO3A-phthalimide compound (site b). The luminescence intensity at site d can be seen to have the highest luminescence intensity.

### Example 5

In this Example, the present inventors illustrate the effectiveness of the luminescence of terbium and Europium complexes according to the present invention in a gel, in particular, agarose gel (agar gel).

Details of the agarose gel are as follows:

### Company: Bioline

### Name: Agarose FineRes

Gel Strength (1%): >=1200 g/cm2
gelling temp, 1.5% Sol.: 36 degrees+/−2 degrees

### Sulphate: <0.14%

### Ash: <0.6%

DNase & RNase: None detected

### Cat No: BIO-41030 (500 g)

### Batch No: AGF5-108B

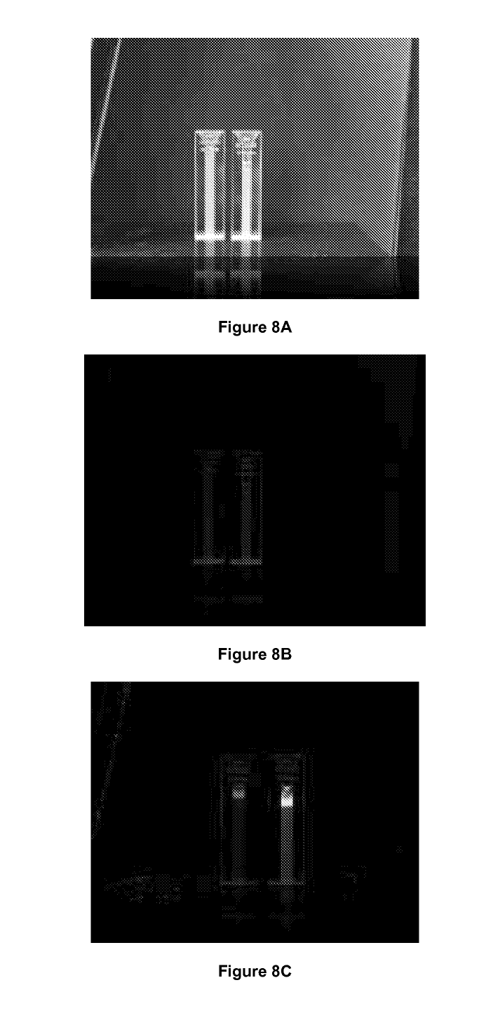

Terbium and Europium DO3A-phthalimide complexes (0.125 mM, pH 4) in Agarose gel (0.5% w/v) was first prepared in separate vials. NaOH solution (5 μL, 50 mM) was carefully dropped on the top of the gel. The photographs shown in FIGS. 8A, 8B and 8C were taken after 5 minutes of addition. The high luminescence intensity of the Terbium and Europium DO3A-phthalamate complexes when illuminated with UV light can be clearly seen in FIG. 8C. In the Figure, the Europium complex is in the left-hand vial, and fluoresced light of a red colour; and the terbium complex is in the right-hand vial and fluoresced light of a green colour.

### Example 6

In this Example, the inventors demonstrate the effectiveness of the intensity of luminescence changes when mixing metal cations at various mole ratios with the terbium complex. The terbium complex was a terbium DO3A-phthalamate complex, formed from the hydrolysis of a terbium DO3A-phthalimide complex, as described in earlier Examples.

In this experiment, metal cations Cu(II), Zn(II), Ca(II), Co(II), Fe(II), Fe(III), Ni(II) were prepared as 0.1 M in deionised water. 0.5 mole equivalent of each of the above metal cation to Tb(III) was titrated into the Tb(III) complex. The luminescence intensities at 544 nm were recorded (see FIG. 9). The pH of the mixture solutions were maintained between 6.6-6.8 using HEPES buffer.

1-20. (canceled)

21. A complex comprising:
a multidentate ligand that is coordinated to a lanthanide ion, wherein
the lanthanide is selected from europium and terbium, and
the multidentate ligand has (i) at least one optionally substituted phthalimide group coordinated to the lanthanide ion or (ii) at least one optionally substituted phthalamate group coordinated to the lanthanide ion.

22. A complex according to claim 21, the complex comprising
the lanthanide ion and the multidentate ligand, wherein the ligand is of formula (I) 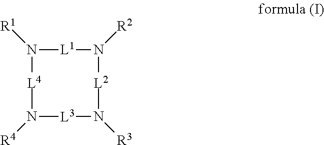
L¹, L², L³, L⁴ are each selected from —(CR⁵R⁵)ₙ—, wherein n is 2 or 3,
R¹, R², R³ and R⁴ are each independently selected from L⁵-X¹ and L⁶-X²,
L⁵ and L⁶ are each independently an organic linker group,
X¹ is an optionally substituted phthalimide group or optionally substituted phthalamate group, and
X² is a group that binds to the lanthanide ion other than a substituted phthalimide group and a optionally substituted phthalamate group,
wherein each R⁵ is independently selected from H and an optionally substituted hydrocarbon group,
and at least one of R¹, R², R³ and R⁴ is L⁵-X¹.

23. The complex according to claim 22, wherein X¹ is an optionally substituted phthalimide group.

24. The complex according to claim 22, wherein X¹ is an optionally substituted phthalamate group.

25. The complex according to claim 22, wherein at least two of R¹, R², R³ and R⁴ is L⁵-X¹.

26. The complex according to claim 22, wherein L¹, L², L³, L⁴ are each selected from —(CR⁵R⁵)ₙ—, wherein each R⁵ is H and n is 2.

27. The complex according to claim 22, wherein in each L⁵-X¹, L⁵ is an optionally substituted alkylene having from 1 to 10 carbons atoms, excluding any substituents that may be present.

28. The complex according to claim 22, wherein in each L⁵-X¹, L⁵ is a linker group of the formula —(CH₂)_{q}—, wherein q is 1 to 5.

29. The complex according claim 22, wherein in each L⁶-X², L⁶ is an optionally substituted alkylene having from 1 to 10 carbons atoms, excluding any substituents that may be present.

30. The complex according to claim 22, wherein in each L⁶-X², L⁶ is a linker group of the formula —(CH₂)_{q}—, wherein q is 1 to 5.

31. The complex according to claim 22, wherein X² is selected from —CO₂, —CO₂R⁶, —O, OR⁶, —NHR⁶, —C(═O)R⁶, —C(═O)N(R⁶)₂, —PO(O)₂, —PO(O)(OR⁶), —PO(OR⁶)₂, —SR⁶, —SOR⁶, —SO₂, —SO₂R⁶, —NHC(═O)R⁶, —NHC(═O)NHR⁶, —NHC(═S)NHR⁶, and Q
wherein each R⁶ is independently selected from H and an optionally substituted hydrocarbon group,
Q is a group selected from 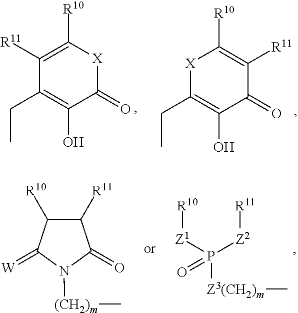
wherein R¹⁰ and R¹¹ are independently selected at each occurrence from: H and an optionally substituted hydrocarbon group;
m is 1-3;
W is two hydrogen atoms;
X is selected from O or NR⁷; wherein R⁷ is selected from H and optionally substituted hydrocarbon, and
Z¹, Z² and Z³ are independently selected from: O, NH, CH₂NH, and a direct bond.

32. The complex according to claim 31, wherein X² is —CO₂.

33. A method of changing the fluorescent properties of a complex, the method comprising:
providing a first complex comprising a multidentate ligand that is coordinated to a lanthanide ion,
wherein the lanthanide is selected from europium and terbium and the multidentate ligand has at least one optionally substituted phthalimide group coordinated to the lanthanide ion,
contacting the complex with an aqueous liquid medium under appropriate conditions, such that at least one phthalimide group is hydrolyzed to a phthalamate group, to form a second complex.

34. The method according to claim 33, wherein the first complex comprises a lanthanide ion and a multidentate ligand, wherein the ligand is of formula (I) 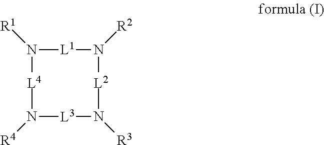
L¹, L², L³, L⁴ are each selected from —(CR⁵R⁵)ₙ—, wherein n is 2 or 3,
R¹, R², R³ and R⁴ are each independently selected from L⁵-X¹ and L⁶-X²,
L⁵ and L⁶ are each independently an organic linker group,
X¹ is an optionally substituted phthalimide group, and
X² is a group that binds to the lanthanide ion other than an optionally substituted phthalimide group and a optionally substituted phthalamate group,
wherein each R⁵ is independently selected from H and an optionally substituted hydrocarbon group,
and at least one of R¹, R², R³ and R⁴ is L⁵-X¹.

35. Use of a complex for detecting a change in pH, wherein the complex comprises a multidentate ligand that is coordinated to a lanthanide ion, wherein the lanthanide is selected from europium and terbium and the multidentate ligand has (i) at least one optionally substituted phthalimide group coordinated to the lanthanide ion or (ii) at least one optionally substituted phthalamate group coordinated to the lanthanide ion.

36. The use according to claim 35, the complex comprising the lanthanide ion and the multidentate ligand, wherein the ligand is of formula (I) 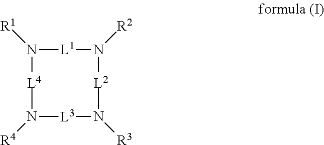
L¹, L², L³, L⁴ are each selected from —(CR⁵R⁵)ₙ—, wherein n is 2 or 3,
R¹, R², R³ and R⁴ are each independently selected from L⁵-X¹ and L⁶-X²,
L⁵ and L⁶ are each independently an organic linker group,
X¹ is an optionally substituted phthalimide group or optionally substituted phthalamate group, and
X² is a group that binds to the lanthanide ion other than a substituted phthalimide group and a optionally substituted phthalamate group,
wherein each R⁵ is independently selected from H and an optionally substituted hydrocarbon group,
and at least one of R¹, R², R³ and R⁴ is L⁵-X¹.

37. The use according to claim 36, wherein X¹ is an optionally substituted phthalimide group.

38. The use according to claim 36, wherein X¹ is an optionally substituted phthalamate group

39. The use according to claim 36, wherein at least two of R¹, R², R³ and R⁴ is L⁵-X¹.

40. The use according to claim 36, wherein X² is —CO₂.
